(19) United States
(12) Patent Application Publication
(10) Pub. No.: US 2026/0257665 A1
(43) Pub. Date: Sep. 3, 2026

(54) HYBRID ELECTRIC VEHICLE PROPULSION SYSTEM CONTROL

(71) Applicant: FCA US LLC, Auburn Hills, MI (US)

(72) Inventors: Cristian Rostiti, Auburn Hills, MI (US); Abdulquadri Oluwatobi Banuso, Auburn Hills, MI (US); Nadirsh D Patel, Auburn Hills, MI (US)

(21) Appl. No.: 19/066,839

(22) Filed: Feb. 28, 2025

(51) Int. Cl. B60W 20/40; B60W 10/02; B60W 10/06; B60W 10/08

(52) U.S. Cl. CPC B60W 20/40; B60W 10/02; B60W 10/06; B60W 10/08; B60W 2710/021; B60W 2710/0644; B60W 2710/0666; B60W 2710/083

(57) ABSTRACT

A hybrid electric vehicle (HEV) includes an internal combustion engine, an electric traction motor, a disconnect clutch selectively connecting the engine and the electric traction motor, a belt starter generator (BSG) unit, an engine control module (ECM) configured to manage engine speed control when the disconnect clutch is open, and a hybrid supervisory control module (HCS) configured to manage engine speed control when the disconnect clutch is closed. A powertrain control system, for managing hybrid torque control authority transfer between the ECM and the HCS, is programmed to turn the engine on, control the engine to reach a predetermined target speed, close the disconnect clutch when the engine reaches the predetermined target speed, and transfer hybrid torque control authority from the ECM to the HCS by simultaneously reducing an ECM torque contribution and increasing an HCS torque contribution until the ECM torque contribution is zero.

### FIELD

The present application relates generally to hybrid electric vehicle control systems and, more particularly, to a vehicle control system for engine speed control authority transfer between engine and hybrid controllers.

### BACKGROUND

A hybrid-electric vehicle (HEV) powertrain typically includes an internal combustion engine, an electric traction motor, a high voltage battery system and a low voltage (e.g., 12 volt) battery system. In such a configuration, power generated from the engine and electric motor may be utilized to drive the vehicle, and the high voltage battery system is utilized to power the electric motor and power/recharge the low voltage battery system via a direct current to direct current (DC/DC) converter and a belt start generator (BSG). During some specific powertrain operations, such as transitioning between electric and hybrid modes, there is a need to transfer engine speed control authority between various control modules. However, some conventional transfers may potentially result in suboptimal performance and efficiency and/or generate torque oscillation or jerk that can be felt at the cabin and impact drivability. Accordingly, while such conventional systems do work well for their intended purpose, there is a desire for improvement in the relevant art.

### SUMMARY

In accordance with one example aspect of the invention, a hybrid electric vehicle (HEV) is provided. In one example implementation, the HEV includes an internal combustion engine, an electric traction motor, a disconnect clutch selectively connecting the engine and the electric traction motor, a belt starter generator (BSG) unit configured to start the internal combustion engine, an engine control module (ECM) configured to manage engine speed control when the disconnect clutch is open, and a hybrid supervisory control module (HCS) configured to manage engine speed control when the disconnect clutch is closed. A powertrain control system, including the ECM and the HCS, is configured to manage hybrid torque control authority transfer between the ECM and the HCS. The powertrain control system is programmed to turn the engine on; control, by the ECM, the engine to reach a predetermined target speed; close the disconnect clutch when the engine reaches the predetermined target speed; and transfer hybrid torque control authority from the ECM to the HCS by simultaneously reducing an ECM torque contribution and increasing an HCS torque contribution until the ECM torque contribution is zero.

In addition to the foregoing, the described HEV may include one or more of the following features: wherein during the hybrid torque control authority transfer, the powertrain control system is further programmed to determine, by the HCS and a physics-based model, a closed loop torque contribution of the ECM, and freeze, by the ECM, a closed loop learning of the ECM prior to reducing the ECM torque contribution; wherein during the hybrid torque control authority transfer, the HCS is configured to activate a closed loop strategy to learn actuation uncertainty and compensate for additional noise factors; and wherein upon the ECM torque contribution reaching zero, the powertrain control system is further programmed to deactivate ECM closed loop control.

In addition to the foregoing, the described HEV may include one or more of the following features: wherein during the hybrid torque control authority transfer, the ECM torque contribution is reduced linearly at a constant rate; wherein during the hybrid torque control authority transfer, the HCS torque contribution is increased proportionally to the ECM torque contribution reduction; a torque converter; wherein the electric traction motor is a P2 motor located between the disconnect clutch and the torque converter; a transmission gearbox configured to receive input torque from the torque converter; and upon completion of the hybrid torque control authority transfer, the HCS is configured to manage speed control of the engine via the electric traction motor.

In accordance with another example aspect of the invention, a method of operating a powertrain control system of a hybrid electric vehicle (HEV) is provided. The HEV includes an internal combustion engine, an electric traction motor, a disconnect clutch, a belt starter generator (BSG) unit, an engine control module (ECM) configured to manage engine speed control when the disconnect clutch is open, and a hybrid supervisory control module (HCS) configured to manage engine speed control when the disconnect clutch is closed.

In one example implementation, the method includes turning the engine on; controlling, by the ECM, the engine to reach a predetermined target speed; closing the disconnect clutch when the engine reaches the predetermined target speed; and transferring hybrid torque control authority from the ECM to the HCS by simultaneously reducing an ECM torque contribution and increasing an HCS torque contribution until the ECM torque contribution is zero.

In addition to the foregoing, the described method may include one or more of the following features: wherein during the hybrid torque control authority transfer, the method further includes determining, by the HCS and a physics-based model, a closed loop torque contribution of the ECM, and freezing, by the ECM, a closed loop learning of the ECM prior to reducing the ECM torque contribution; wherein during the hybrid torque control authority transfer, the method further includes activating, on the HCS, a closed loop strategy to learn actuation uncertainty and compensate for additional noise factors; and deactivating ECM closed loop control when the ECM torque contribution reaches zero.

In addition to the foregoing, the described method may include one or more of the following features: wherein during the hybrid torque control authority transfer, the ECM torque contribution is reduced linearly at a constant rate; wherein during the hybrid torque control authority transfer, the HCS torque contribution is increased proportionally to the ECM torque contribution reduction; wherein the HEV further comprises a torque converter; wherein the electric traction motor is a P2 motor located between the disconnect clutch and the torque converter; wherein the HEV further comprises a transmission gearbox configured to receive input torque from the torque converter; and managing, by the HCS, speed control of the engine via the electric traction motor upon completion of the hybrid torque control authority transfer.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example hybrid electric vehicle (HEV) architecture in accordance with the principles of the present application;

FIG. 2A is a block diagram illustrating example forces involved during an EV creep to hybrid creep, in accordance with the principles of the present application;

FIG. 2B is a graph illustrating an example control authority transfer of the vehicle shown in FIG. 1, in accordance with the principles of the present application;

FIG. 3A illustrates an example control logic flow for vehicle control utilizing the control authority transfer, in accordance with the principles of the present application; and

FIG. 3B illustrates another example control logic flow for the control authority transfer event, in accordance with the principles of the present application.

### DETAILED DESCRIPTION

As discussed above, a hybrid electric vehicle (HEV) powertrain includes both an internal combustion engine and an electric traction motor (e-motor) to propel the vehicle, for example, in an EV mode (e-motor only) or a hybrid mode (engine & e-motor). Typically, control strategies and currently implemented software architectures rely on a hierarchical pilot-co-pilot architecture, where a supervisor control optimizes overall power and energy management, while local control performs local optimization and tracking of the desired reference determined by the supervisor. When the control architecture is hierarchical and functions are performed in a domain-based fashion by different CPUs, authority handover might be needed in case of variations in the powertrain working conditions. This might occur, for instance, when the energy optimization function decides to shift the power-split between the engine and the motors. However, conventional transfers may potentially result in suboptimal performance and efficiency and/or generate torque oscillation or jerk that can be felt at the cabin and impact drivability. Accordingly, described herein are control systems and methods for engine speed control authority transfer from a closed-loop speed control with a low-level engine control module (ECM) to a hybrid supervisory control system module (HCS).

As previously noted, a hierarchical control architecture is generally employed for hybrid torque control, where the supervisor CPU oversees system-level objectives, and a slave CPU manages lower-level control tasks. Frequently, control authority must be transferred between the two CPUs to achieve optimal coordination and synchronization. When a closed-loop component is utilized, accurately determining its actual contribution to the controlled system can be challenging, for example, because closed-loop components are often designed to compensate for unknown dynamics, component variations, and actuation uncertainties. For example, in regard to actuation uncertainties, a CPU may be given a specific torque to be generated, but current working conditions (e.g., temperature, pressure, age, actuation specifications, etc.) might not be known or measured with precision, engine non-linear dynamics may be difficult to predict, and other systems may have priority (e.g., emissions, noise/vibrations, etc.). As such, the system described herein is configured to provide a closed-loop component factor transfer and coordination between two CPUs operating at different hierarchical levels within a complex system.

The system enables seamless control authority transition between the supervisor and slave CPUs, ensuring optimal system performance and robustness. To mitigate disturbances and uncertainties during the transition, the system utilizes a model-based learning phase that reduces actuation mismatch while focusing on the authority transfer of engine speed tracking between the ECM and the HCS. Specifically, the information embedded within the engine's closed-loop system is estimated through a system model and subsequently transmitted to the HCS. To mitigate the potential influence of any uncertainties inherent in the model on the overall system's behavior, a temporal window is employed to progressively diminish the contribution of the existing closed-loop component on the engine side while concurrently enabling the hybrid supervisory side to initiate its learning process. The technique employs a combined feedforward-feedback structure to mitigate the impact of potential uncertainties and noise. This approach prioritizes computational efficiency by leveraging existing functions within the control architecture, thereby minimizing the memory and computational burden on the embedded systems. The resulting system provides enhanced performance and reliability, as described herein in more detail.

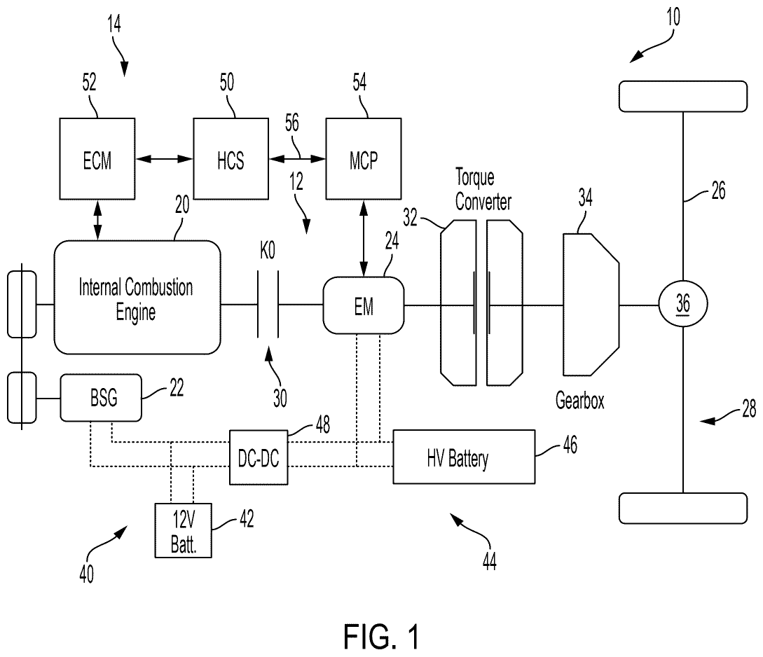

With initial reference to FIG. 1, a schematic diagram of a hybrid electric vehicle (HEV) 10 is illustrated having a hybrid powertrain 12 and a powertrain control system 14 according to example implementations of the disclosure. In the illustrated example, the powertrain 12 generally includes an internal combustion engine 20 and two electric motors, including a low voltage (e.g., 12V) belt-driven starter generator (BSG) and inverter unit 22 (e.g., P1 motor), and a higher voltage (e.g., 400V) electric traction motor 24 (e.g., P2 motor). It will be appreciated that the illustrated configuration is merely exemplary, and the techniques described herein may be applied to various hybrid vehicle powertrain configurations.

In the example embodiment, the engine 20 combusts a mixture of air and fuel (e.g., gasoline) within cylinders to drive pistons and generate drive torque to a front or rear axle 26 via a driveline 28 that includes a disconnect clutch 30, a torque converter 32, a transmission gearbox 34, and a final drive (differential) 36. The electric motor of the BSG unit 22 is utilized to control engine stop/start operations to improve vehicle fuel economy, and the electric traction motor 24 is configured to selectively provide drive torque to the front and/or rear axle 26. It will be appreciated that transmission 34 may have any suitable configuration that enables HEV 10 to function as described herein.

To provide electric power, the HEV 10 includes a low voltage battery system 40 having a battery 42, and a high voltage (HV) battery system 44 having a HV traction battery 46. In the example description, the low voltage battery system 40 is a 12V system and the HV battery system 44 is a 400V system and will be described as such. However, it will be appreciated that battery systems 40, 44 may have different operating voltages.

In the example embodiment, the low voltage battery system 40 is configured to support various 12V loads of the HEV 10, for example, to power various electrical components or start the engine 20. The HV battery system 44 is configured to power high voltage loads such as the traction motor 24 and a DC/DC converter 48. In general, the electric traction motor 24 is powered by the HV battery system 44, and the low voltage BSG unit 22 is powered by the low voltage battery system 40 and/or the HV battery system 44. The DC/DC converter 48 is an actuator configured to convert high voltage (e.g., 48V) to low voltage (e.g., 12V) to charge the 12V battery 42 and support various 12V loads of the HEV 10.

In the example embodiment, the hybrid powertrain 12 is controlled by the powertrain control system 14, which generally includes a hybrid supervisory control system module (HCS) or controller 50, an engine control module (ECM) or controller 52, and a motor control processor (MCP) 54. The HCS 50 is a central supervisory control configured to communicate with various components/modules of the hybrid powertrain 12 via a CAN bus 56. The ECM 52 is configured to control engine 20 to provide torque and speed, for example, to drive the 12V BSG unit 22. The HCS 50 is configured to control and monitor the engine 20 via the ECM 52, and control electric motor 24 via the MCP 54.

The BSG unit 22 is an actuator configured to be utilized as a starter when the HEV 10 needs to crank the engine 20. The BSG unit 22 is configured to operate in an alternator mode to charge the 12V battery 42 and support 12V loads while the engine 20 is running. The BSG unit 22 is directly controlled by the MCP 54, which is a controller configured for bi-directional communication with the HCS 50 via the CAN bus 56. The HCS 50 is configured to control the electric motor 24 by forwarding signals, such as operation state, torque command, and voltage setpoints to the MCP 54, and the MCP 54 provides feedback signals to the HCS 50 related to the electric motor 24, such as operation status, output current, and voltage.

In the example implementation, the HEV 10 is configured to operate in four primary modes: (i) EV Mode with the torque converter 32 open and the disconnect clutch 30 open for EV creep and EV launch; (ii) Hybrid Mode with the torque converter 32 open and the disconnect clutch 30 engaged (locked) for hybrid creep and hybrid launch; (iii) EV Mode with the torque converter 32 closed and the disconnect clutch 30 open for EV locked; and (iv) Hybrid Mode with the torque converter 32 closed and the disconnect clutch 30 engaged for hybrid locked. The state transition of interest for this disclosure is ‘hybrid creep’ with the engine in input speed control.

In one example, during EV creep and launch, the torque from e-motor 24 goes into the open torque converter 32, so the torque arrives to the wheels due to the fluid coupling (e.g., speed of the e-motor and input of the transmission are different, but torque is still transmitted from the e-motor to the transmission). Hybrid creep is similar to EV creep, but in addition the clutch 30 is closed, so the engine 20 and e-motor 24 are “rigidly” moving together. In EV lock, the torque converter 32 is locked, so the e-motor 24 is connected “rigidly” to the wheels. Hybrid lock is similar to EV lock, but in addition the clutch 30 is closed, so engine 20 and e-motor 24 are “rigidly” moving together.

In general, the BSG unit 22 is typically not powerful enough to control the speed of the engine 20. Therefore, when the disconnect clutch 30 is open, the ECM 52 is in charge of tracking the reference speed of the engine 20. Once the disconnect clutch 30 is closed, the HCS 50 can now regulate the engine speed through the electric motor 24. It may be preferred to utilize the electric motor 24 for speed control as it is a more precise and efficient way of controlling the engine speed (input shaft speed). Accordingly, there is a need to transfer authority from the ECM 52 to the HCS 50 once the engine 20 is firing and the clutch 30 is closed. During this transition, torque oscillation or jerk may be transferred through the vehicle wheels affecting drivability, therefore a smooth handover of control authority is desired.

This speed control is performed through a combination of feedforward and feedback algorithms, such as with one or more proportional integral derivative (PID) controllers (not shown). While the open loop component can be easily transferred between the ECM 52 and the HCS 50, the closed loop components contain learned features to compensate for actuation and model uncertainties. These are typically actuation dependent, thus transferring them directly from the engine 20 to the electric motor 24 may not be feasible. As the authority is transferred, to achieve a smooth operation, the error in the control actuation learned (on the engine side) is adjusted to the new actuator (the electric motor 24). Accordingly, there is a need to transfer control authority from the ECM 52 to the HCS 50 during specific powertrain operations, and it is imperative to perform this transfer while preventing any impact to drivability.

In operation, the HCS 50 is configured to optimize torque and/or speed and provide these quantities as references to local controllers. In the described operation, the local controllers include the ECM 52 and the MCP 54. Both controllers 52, 54 are tasked with ensuring, within reasonable performance bounds, that the torque and/or speeds allocated by the HCS 50 are met. In some examples, the ECM 52 generally possesses a greater degree of freedom in achieving the desired torque. This flexibility allows for balancing other optimization objectives within the engine control, such as fuel economy and emissions. Low-level, short-term optimizations may be delegated to the ECM 52 to address. Conversely, while the MCP 54 remains a complex controller with diverse functionalities ranging from motor controls to shaft active damping, it typically exhibits more straightforward and precise tracking of commanded torque due to the nature of its actuator. Other interfaces and modules, although present in general, have been omitted for the sake of simplicity.

During the transition from EV drive mode to hybrid mode, precise synchronization between the engine and electric motor speeds is imperative prior to engaging the clutch 30 to propagate engine torque to the wheels. While the BSG 22 can reliably achieve a minimum speed at which the engine 20 can initiate and sustain stable combustion, the BSG 22 may exhibit insufficient power to accelerate the engine 20 to the desired synchronization speed, a scenario commonly referred to as a low electric power authority condition. In such instances, the engine 20 must autonomously generate torque to accelerate and subsequently track the target speed until the disconnect clutch 30 is engaged. Consequently, the ECM 52 assumes responsibility for managing engine speed control before the disconnect clutch 30 is engaged. Once the clutch 30 is closed, the HCS 50 gains the capability to regulate input speed by utilizing the electric motor 24 as an actuator, which offers a more efficient and precise means of controlling input shaft speed. Because variations in input speed influence torque transfer through the torque converter 32 thereby affecting the torque at the wheels, the powertrain control system 14 is configured to ensure a seamless handover of input speed tracking between controllers 50, 52.

In the example embodiment, both a model-based open loop component and a closed loop component are used for speed tracking. The open loop component is tasked to achieve the target based on the calibrated characteristics of the powertrain. Due to uncertainties and noise, a closed-loop component is utilized in conjunction to guarantee a good level of tracking performance. The system is configured to maintain precise input speed regulation to ensure smooth powertrain operation, optimal vehicle performance, and enhanced driver comfort when the system is operated in a closed loop mode.

Challenges may arise when the engine, a traditionally imperfect torque estimator, is under closed loop control. The feedforward model used to actuate the electric machine relies on such input to determine the appropriate motor torque command. However, inaccuracies may lead to excessive control effort on the ECM 52, potentially compromising system efficiency and fuel economy and increasing the risk of control windup. In contrast, the electric motor 24 provides a more accurate estimation of input torque, derived from the induced currents on the stator. This precise control capability and instantaneous response enable the motor to effectively manage the transition from engine-based to motor-based input speed control.

A primary objective of the control authority transfer described herein is to ensure a seamless transition between the engine 20 and electric motor 24 for closed loop actuator control of input speed. This smooth transition minimizes driveline disturbances while capitalizing on the synergistic benefits of the engine's fuel efficiency and the motor's precise torque control. By effectively managing this control authority transfer, the system can optimize overall powertrain performance and enhance the driving experience.

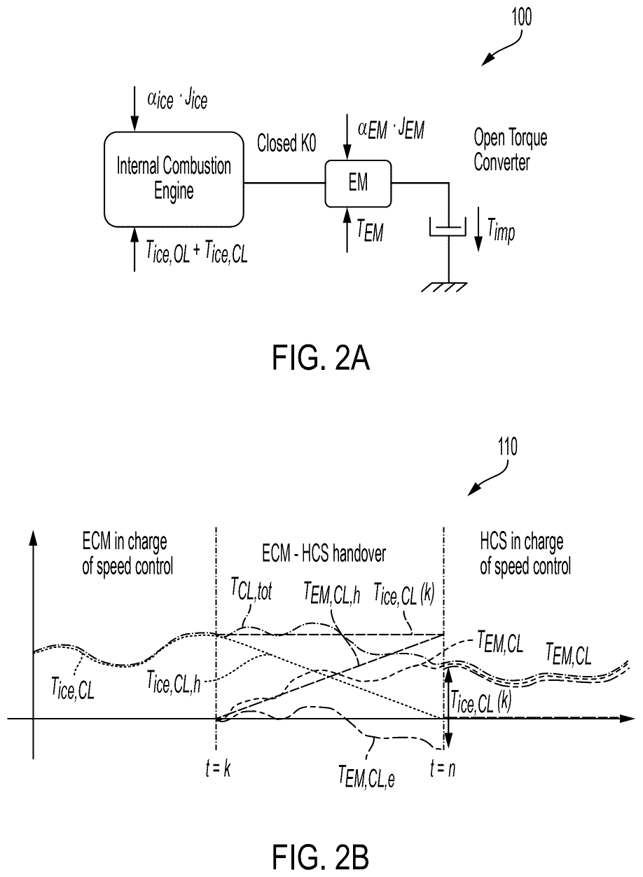

Operation of the powertrain control system 14 with transfer of control authority from the ECM 52 to the HCS 50 will now be described in more detail. In the example embodiment, while the ECM 52 is operating, its closed-loop control enables adjustments for actuation uncertainties and noise. To facilitate a successful handover, the HCS 50 accurately quantifies the degree of closed-loop control currently in effect. During the specific working condition, a model can be employed to estimate, with a certain level of precision, the extent of closed-loop contribution. To this end, a simplified block diagram 100 is shown in FIG. 2A. Because the closed-loop component also accounts for actuation uncertainties, simply communicating the commanded closed-loop torque computed from the ECM 52 may not yield a sufficiently accurate assessment.

The system is designed to actuate using a different actuator with higher actuation fidelity (an e-motor compared to an engine), thus a precise understanding of the closed-loop value is paramount. The following equation (1) describes the physical shaft (e.g., from engine 20 to torque converter 32) in the scenario of interest (K0 closed, torque converter open, engine on):

$${T}_{ice , OL} + {T}_{ice , CL} - {α}_{ice} \cdot {J}_{ice} + {T}_{EM} - {α}_{EM} \cdot {J}_{EM} - {T}_{imp} = 0 \qquad ( 1 )$$

Where T_{ice,OL} represents the open loop component actuated by the engine, and T_{ice,CL} is the closed loop component currently actuated through the engine. The inertia components α_{ice}·J_{ice}, α_{EM}·J_{EM}, the motor torque T_{EM}, and impeller torque Tᵢₘₚ can be estimated with high fidelity due to higher resolution of available speed sensors, coupled with bench testing to obtain component equivalent inertias and similar strategies. While both torque components T_{ice,OL} and T_{ice,CL} are subject to uncertainties arising from actuation, the described strategy incorporates these uncertainties within the closed-loop term. Given the aforementioned considerations, Equation (1) can be leveraged to derive the closed-loop component within the HCS 50.

With additional reference to FIG. 2B, in the example implementation, the powertrain control system 14 leverages a predetermined temporal window 110 within which the authority handover occurs. During this window, the ECM 52 progressively diminishes its closed-loop contribution (e.g., linearly). At the same time, the HCS 50 incrementally increases its torque command, and a closed-loop control mechanism is active within the HCS 50 to facilitate the learning of uncertainties during the handover process. This approach is configured to mitigate abrupt changes in shaft torque.

With continued reference to FIG. 2B, in one example, the powertrain control system 14 is configured to perform the following operations. First, when the decision to execute the closed-loop handover is communicated (time k), the closed-loop contribution from the ECM side is estimated on the HCS side through Equation (1). A specific, constant rate is utilized by the ECM 52 to linearly or proportionally (e.g., proportional to its current value) reduce its current closed-loop component. At this stage, the closed-loop algorithm is no longer active on the ECM side. Only the value at the beginning of the time window is utilized as a reference to perform the linear reduction. Once the closed-loop component diminishes to zero, the window 110 is declared closed (time n).

As the ECM 52 progressively reduces its torque contribution, the HCS 50 simultaneously increases its torque contribution to attain an estimated value of the closed-loop component within the designated time window. Despite potential discrepancies between the estimated closed-loop component and the actual value due to actuation uncertainties and other noise factors combined within the closed-loop component, the cumulative summation of the closed-loop component over the ECM 52 ultimately converges with that of the HCS 50, resulting in the same initial torque applied by the ECM 52, as shown in Equation (2) below. This convergence occurs under the assumption of negligible static offset.

$${T}_{ice , CL , h} ( j ) + {T}_{EM , CL , h} ( j ) = {T}_{ice , CL} ( k ) \qquad ( 2 )$$

Where j is time within the handover window, i.e., k<j<n, and T_{ice,CL,h}(j)+T_{EM, CL,h}(j) is the contribution of the engine and motor of the closed loop handover during the exchange window.

Throughout the handover process, the closed-loop correction of uncertainties is executed by the HCS 50 through the electric motor(s) 24. Specifically, when the window 110 begins (time k), a closed-loop control mechanism (e.g., a PID-based algorithm) is employed to regulate the tracking of the speed reference. This action requires the motor exerting a specific torque T_{EM,CL,e} onto the shaft (e.g., engine 20 to torque converter 32). This approach enables the HCS 50 to progressively learn and mitigate any accumulating uncertainties during the handover process. Therefore, although the assumption of negligible static offset (used in Equation (2)) may not be strictly accurate in practice, the closed-loop component, now under the control of the HCS 50, will nonetheless ensure a smooth transition.

Effectively, the engine 20 and electric motor(s) 24 have the following torques applied during the handover window:

$${T}_{ice} ( j ) = {T}_{ice , OL} ( j ) + {T}_{ice , CL , h} ( j ) \qquad ( 3 )$$

$${T}_{EM} ( j ) = {T}_{EM , CL} ( j ) = {T}_{EM , CL , h} ( j ) + {T}_{EM , CL , e} ( j ) \qquad ( 4 )$$

With total closed-loop contribution as:

$${T}_{CL , tot} ( j ) = {T}_{EM , CL} ( j ) + {T}_{ice , CL} ( j ) \qquad ( 5 )$$

Upon completion of the ramping process and the subsequent declaration of the handover window closure, the learned closed-loop contribution from the ECM 52 is incorporated into the integral term of the PID-based algorithm. This approach is adopted to streamline the process and ensure that a single variable is utilized to represent the handover throughout its duration. By initializing this variable at the conclusion of the process and transferring its value to the integral term, it may be effectively reused for future handovers. From a control engineering perspective, since the learned closed-loop component essentially represents a correction for uncertainties, it is logical to integrate it into the integral term of the PID-based algorithm. This enables the system to compensate for these uncertainties in a systematic manner.

Formally, the handover can be expressed by the following equations for each phase of the transition. At time t<k:

$${T}_{ice , CL} ( t ) = f ( {e}_{{N}_{i}} ( t ) ) \\ {T}_{EM , CL} ( t ) = 0 \qquad ( 6 )$$

Where f(e_{N}_{ᵢ}(·)) is a proper closed loop algorithm within the ECM with an objective of the reduction of error between actual speed and desired speed. At time k≤t<n:

$${T}_{h} ( t ) = \partial T \cdot {T}_{s} \cdot ( t - k ) \\ {T}_{ice , CL} ( t ) = {T}_{ice , CL} ( k ) - {T}_{h} ( t ) \\ {T}_{EM , CL} ( t ) = g ( {e}_{{N}_{i}} ( t ) ) + {\hat{T}}_{ice , CL} \frac{{T}_{h} ( t )}{{T}_{ice , CL} ( k )} \qquad ( 7 )$$

Where Tₕ is the variation of engine and motor closed loop component, and ∂T·Tₛ is the slope of the decrease in closed loop component of the ECM side multiplied by the sampling time of the closed loop functionality. Further, g(e_{N}_{ᵢ}(·)) is a proper closed loop algorithm within the MCP with an objective of the reduction of error between actual speed and desired speed, and \hat{T}_{ice,CL} is the engine closed loop component estimated by the HCS at time t=k. Notably, if \hat{T}_{ice,CL}=T_{ice,CL}(k), then the rate of variation of engine and motor closed loop is identical. With respect to Equations (3) and (4):

$${T}_{ice , CL , h} ( t ) = {T}_{ice , CL} ( k ) - {T}_{h} ( t ) \\ {T}_{EM , CL , h ( t )} = {\hat{T}}_{ice , CL} \frac{{T}_{h} ( t )}{{T}_{ice , CL} ( k )} \\ {T}_{EM , CL , e} ( t ) = g ( {e}_{{N}_{i}} ( t ) ) \qquad ( 8 )$$

Lastly, at time t≥k:

$${T}_{ice , CL} ( t ) = 0 \\ {T}_{EM , CL} ( t ) = g ( {e}_{{N}_{i}} ( t ) ) + {\hat{T}}_{ice , CL} \qquad ( 9 )$$

From this moment on, the handover transition is considered complete, and the HCS 50 now oversees the closed-loop component through the electric motor 24, which affects the total torque applied to the engine shaft to correctly achieve the target engine speed.

Accordingly, the powertrain control system 14 is configured to seamlessly transfer speed control authority from the ECM 52 to the HCS 50 based on a physics-oriented model of the powertrain. The model is utilized to determine how much closed-loop component is effectively needed from the HCS 50, based on a predetermined window of time in which the transfer occurs. While the learned closed-loop component is transferred, additional closed-loop actions are taken to compensate for any additional noise or uncertainty.

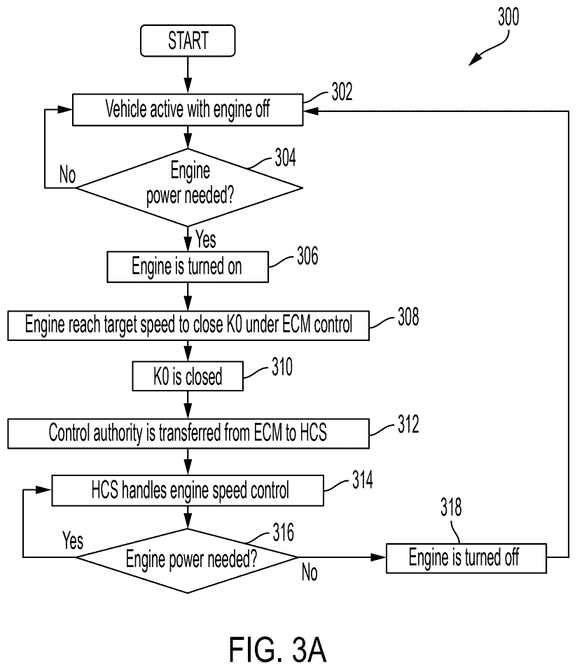

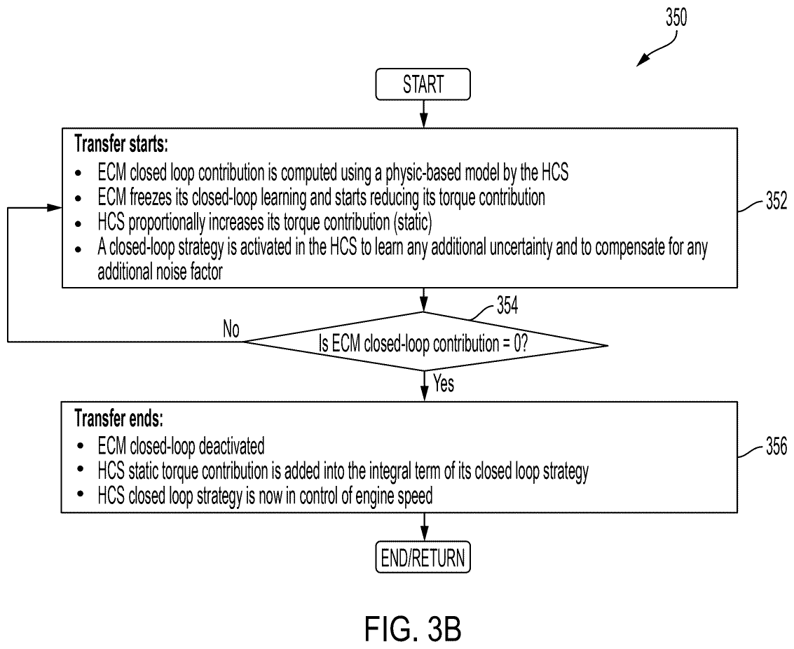

With reference now to FIG. 3A, a flow diagram of an example method 300 of operating the powertrain control system 14 to transfer control authority from the ECM 52 to the HCS 50 is illustrated according to the principles of the present application. While the method 300 specifically references the HEV 10 and its components for illustrative/descriptive purposes, it will be appreciated that the method 300 could be applicable to any suitably configured electrified vehicle.

In the example embodiment, the method begins at 302 and a supervisory controller (“control”), such as HCS 50, determines the vehicle is active with the engine 20 OFF. At 304, control determines if engine power is needed. If no, control returns to 302. If yes, control proceeds to 306 and the engine 20 is turned on (e.g., via the BSG 22). At 308, the ECM 52 controls the engine 20 to reach a predetermined target speed to close the disconnect clutch 30.

At 310, control closes the disconnect clutch 30. At 312, control authority is transferred from the ECM 52 to the HCS 50, as previously described herein (see also FIG. 3B). At 314, the HCS 50 now performs the engine speed control after the control authority transfer is completed. At 316, control determines if engine power is still needed/required. If yes, control returns to 314. If no, at 318, control turns off the engine 20. The control method then ends or returns to 302.

With reference now to FIG. 3B, a flow diagram of an example method 350 of operating the powertrain control system 14 to transfer control authority from the ECM 52 to the HCS 50 is described in more detail. This method 350 may be utilized for the previous step 312 described in FIG. 3A. In the example embodiment, the method begins at 352 where the transfer of control authority is initiated. Specifically, control computes an ECM closed loop torque contribution, for example using a physics-based model. The ECM 52 freezes its closed-loop learning and begins linearly/gradually reducing its torque contribution. The HCS 50 also begins increasing its torque contribution, for example, in proportion to the ECM torque contribution reduction. HCS 50 then initiates a closed-loop strategy to learn any additional uncertainty and to compensate for any additional noise factors.

At 354, control determines if the ECM closed-loop torque contribution is equal to zero. If no, control returns to 352. If yes, control proceeds to 356 and ends the control authority transfer between the ECM 52 and the HCS 50. Specifically, the ECM closed-loop operation is deactivated, and the HCS static torque contribution is added into the integral term of its closed-loop strategy. The HCS closed-loop strategy is now in command. Control then ends or returns to 352 after another engine start.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A hybrid electric vehicle (HEV), comprising:
an internal combustion engine;
an electric traction motor;
a disconnect clutch selectively connecting the engine and the electric traction motor;
a belt starter generator (BSG) unit configured to start the internal combustion engine;
an engine control module (ECM) configured to manage engine speed control when the disconnect clutch is open;
a hybrid supervisory control module (HCS) configured to manage engine speed control when the disconnect clutch is closed; and
a powertrain control system, including the ECM and the HCS, for managing hybrid torque control authority transfer between the ECM and the HCS, the powertrain control system programmed to:
turn the engine on;
control, by the ECM, the engine to reach a predetermined target speed;
close the disconnect clutch when the engine reaches the predetermined target speed; and
transfer hybrid torque control authority from the ECM to the HCS by simultaneously reducing an ECM torque contribution and increasing an HCS torque contribution until the ECM torque contribution is zero.

2. The HEV of claim 1, wherein during the hybrid torque control authority transfer, the powertrain control system is further programmed to:
determine, by the HCS and a physics-based model, a closed loop torque contribution of the ECM; and
freeze, by the ECM, a closed loop learning of the ECM prior to reducing the ECM torque contribution.

3. The HEV of claim 1, wherein during the hybrid torque control authority transfer, the HCS is configured to activate a closed loop strategy to learn actuation uncertainty and compensate for additional noise factors.

4. The HEV of claim 1, wherein upon the ECM torque contribution reaching zero, the powertrain control system is further programmed to deactivate ECM closed loop control.

5. The HEV of claim 1, wherein during the hybrid torque control authority transfer, the ECM torque contribution is reduced linearly at a constant rate.

6. The HEV of claim 5, wherein during the hybrid torque control authority transfer, the HCS torque contribution is increased proportionally to the ECM torque contribution reduction.

7. The HEV of claim 1, further comprising a torque converter.

8. The HEV of claim 7, wherein the electric traction motor is a P2 motor located between the disconnect clutch and the torque converter.

9. The HEV of claim 7, further comprising a transmission gearbox configured to receive input torque from the torque converter.

10. The HEV of claim 1, upon completion of the hybrid torque control authority transfer, the HCS is configured to manage speed control of the engine via the electric traction motor.

11. A method of operating a powertrain control system of a hybrid electric vehicle (HEV) having an internal combustion engine, an electric traction motor, a disconnect clutch, a belt starter generator (BSG) unit, an engine control module (ECM) configured to manage engine speed control when the disconnect clutch is open, and a hybrid supervisory control module (HCS) configured to manage engine speed control when the disconnect clutch is closed, the method comprising:
turning the engine on;
controlling, by the ECM, the engine to reach a predetermined target speed;
closing the disconnect clutch when the engine reaches the predetermined target speed; and
transferring hybrid torque control authority from the ECM to the HCS by simultaneously reducing an ECM torque contribution and increasing an HCS torque contribution until the ECM torque contribution is zero.

12. The method of claim 11, wherein during the hybrid torque control authority transfer, the method further comprises:
determining, by the HCS and a physics-based model, a closed loop torque contribution of the ECM; and
freezing, by the ECM, a closed loop learning of the ECM prior to reducing the ECM torque contribution.

13. The method of claim 11, wherein during the hybrid torque control authority transfer, the method further comprises:
activating, on the HCS, a closed loop strategy to learn actuation uncertainty and compensate for additional noise factors.

14. The method of claim 11, further comprising:
deactivating ECM closed loop control when the ECM torque contribution reaches zero.

15. The method of claim 11, wherein during the hybrid torque control authority transfer, the ECM torque contribution is reduced linearly at a constant rate.

16. The method of claim 15, wherein during the hybrid torque control authority transfer, the HCS torque contribution is increased proportionally to the ECM torque contribution reduction.

17. The method of claim 11, wherein the HEV further comprises a torque converter.

18. The method of claim 17, wherein the electric traction motor is a P2 motor located between the disconnect clutch and the torque converter.

19. The method of claim 17, wherein the HEV further comprises a transmission gearbox configured to receive input torque from the torque converter.

20. The method of claim 11, further comprising:
managing, by the HCS, speed control of the engine via the electric traction motor upon completion of the hybrid torque control authority transfer.
